(19) United States
(12) Patent Application Publication
(10) Pub. No.: US 2013/0016099 A1
(43) Pub. Date: Jan. 17, 2013

(54) Digital Rendering Method for Environmental Simulation

(71) Applicants: Robb Rinard, Phoenix, AZ (US); Rick Baltman, Phoenix, AZ (US)

(72) Inventors: Robb Rinard, Phoenix, AZ (US); Rick Baltman, Phoenix, AZ (US)

(73) Assignee: 2XL Games, Inc., Phoenix, AZ (US)

(21) Appl. No.: 13/548,101

(22) Filed: Jul. 12, 2012

Related U.S. Application Data
(60) Provisional application No. 61/507,555, filed on Jul. 13, 2011.

(51) Int. Cl. G06T 17/00; G06T 15/40; G06T 15/00

(52) U.S. Cl. 345/420; 345/419; 345/422

(57) ABSTRACT

A method for producing video simulations uses two-dimensional HDR images and LIDAR optical sensor data to deliver a photo-realistic simulated sporting event experience to a display. The playing environment is mapped using a data collection process that includes contour mapping the environment, photographing the environment, and associating the images with the contour mapping data. Preferably, the HDR camera is used in conjunction with a differential global positioning system that records the position and heading of the camera when the photo is taken. A polygon mesh is obtained from the contour data, and each image is projected onto a backdrop from the perspective of a simulated camera to create a set, which is then stored in a set database. The simulated environment is created by selecting the set needed for the simulation and incorporating simulation elements into the set before rendering the simulated camera's view to the display.

### CROSS-REFERENCE TO RELATED APPLICATIONS

This application is a nonprovisional application and claims the benefit of copending U.S. Pat. App. Ser. No. 61/507,555, filed Jul. 13, 2011 and incorporated herein by reference.

### FIELD OF INVENTION

This invention relates to methods of producing video simulations. This invention relates particularly to a method for producing sports simulations on a computer.

### BACKGROUND

The use of computer-generated imagery (“CGI”) to create sports simulations is well known, dating back to the first video games released for arcade and console video game systems in the mid-1980s. In addition, television broadcast producers use CGI and digital rendering processes to illustrate aspects of the sport during a broadcasted event. Approaches to simulating a sporting event vary, but the most prevalent modern approach endeavors to create a course, arena, or field environment that is as true-to-life as possible. Such an environment includes the visual appearance of the environment as well as player and ball movement and collision physics. Widely accepted games that attempt to recreate the golf experience, for example, include TIGER WOODS PGA TOUR® by EA Sports and GOLDEN TEE® Golf by Incredible Technologies.

Such simulations are built on a processing engine designed to work on one or more platforms, such as arcade or console video game systems or personal computers. The processing engine renders CGI and other graphics, and also implements the physical constraints of the simulated environment. Typically, the processing engine produces the simulated environment on a display by identifying, describing, and rendering thousands of polygons that embody the elements of the simulation. Unfortunately, existing rendering methods require significant processing power to render a single scene, which in a golf simulation may include the ground and sky, the green, the fairway, water and sand hazards, vegetation, background elements such as homes or spectators, the golfer's avatar, and the ball and associated physics, because each of these elements is represented by polygons. A typical rendered scene may comprise millions of such polygons. As a result, the realism of the simulation is limited by the processing power of the system, and load times may be extensive. This is particularly problematic for computing devices such as smartphones and tablet computers with relatively small processing capabilities. A method for rendering the sporting environment with more realism and less load and processing time is needed.

One known approach, directed to golf simulations and described in U.S. Pat. No. 7,847,808, uses a method of compositing a two-dimensional photographic image with a three-dimensional representation of the golf ball and pin to produce a realistic view. The position of the golf ball is ascertained in three-dimensional space relative to the camera that took the picture and then rendered onto a view plane which is then combined into the image, so that the ball appears to be in the image. This method produces a realistic background and reduces processor requirements and load times in comparison to other known approaches. However, overall realism is lacking for several reasons. First, the described method only addresses the ball's contact with the ground, so collisions with other environmental elements are not accounted for. Second, because the environment is not three-dimensional, lighting and shadows cannot be accurately modeled. Third, because the course is projected on a planar surface, the user cannot move or rotate the camera to better ascertain the surroundings. Additionally, compositing the two- and three-dimensional representations requires processing time and resources. A more realistic simulation is needed.

Therefore, it is an object of this invention to provide a method for producing a digital simulation of a sporting event. It is a further object that the method produce a simulation that is substantially realistic. It is a further object that the simulation be a golf simulation. Another object of this invention is to provide a method for producing a realistic digital simulation of a golf course that requires less processing power than known methods.

### SUMMARY OF THE INVENTION

A method for producing video simulations uses three-dimensional contour data and two-dimensional photographic images to deliver a photo-realistic simulated sporting event experience to a display. The environment of the sporting event is mapped using a data collection process that includes contour mapping the environment, photographing the environment to obtain at least one set of images that portray the environment, and associating the images with the contour mapping data. Preferably, Light Detection and Ranging (“LIDAR”) technology is used to contour map the environment. Preferably, the photographic images are high dynamic range (“HDR”) panoramic images obtained using an HDR-capable camera. Preferably, the camera is used in conjunction with a differential global positioning system (“GPS”) that records the position and heading of the camera when the photo is taken.

A processing engine obtains a polygon mesh and heightfield from the contour mapping data to create a polygonal backdrop. The processing engine projects each photographic image onto the polygonal backdrop from the position and heading of a simulated camera to create a set, which is then stored in a set database. Each set thus represents a possible scene in the sporting event. The processing system continues creating sets until the environment is represented by the set database to a desired level of detail. In a preferred embodiment, the view of the set from the perspective of the simulated camera is rendered to the display screen of a smartphone, tablet, monitor, or television.

The simulated environment is created by rendering, in sequence, one or more particular sets to present the sporting event. The sequence of rendered sets represents progress through the simulated environment, such as by hitting consecutive golf shots to progress from tee to pin of a hole. Where multiple sets are present in the set database, an algorithm is used to select the proper set, then simulation elements are incorporated into the proper set before rendering the simulated camera's view to the display. The physics of movement within the simulation are governed by physical rules and the position of entities with respect to each other and to the polygonal mesh and heightfield. By presenting the simulated environment in sets with only portions of the environment instead of rendering the complete environment for each scene, a realistic digital simulation is presented that requires less processing power than known methods. The data collection, environment generation, and presentation processes may be used for any sporting event that can be realistically simulated from substantially stationary camera angles.

### BRIEF DESCRIPTION OF THE DRAWINGS

FIG. 1 is a flowchart of the present method for obtaining hole data and creating sets.

FIG. 2 is a top view of a hole with a grid superimposed to show possible imaging device locations and possible divisions for discrete areas.

FIG. 3 is a perspective view of a set before the set's image is applied.

FIG. 4 is a perspective view of the set of FIG. 3 with the set's image applied.

FIG. 5 is a perspective view of the set of FIG. 4 showing a player and a ball placed in the set.

FIG. 6 is a front view of the set of FIG. 5 shown from the simulated camera point of view.

FIG. 7 is a flowchart of the present method for rendering the simulation to a display.

### DETAILED DESCRIPTION OF THE INVENTION

The present method of producing video simulations is directed to simulating a real-world sporting environment wherein the event may be realistically presented from real or simulated cameras that are substantially stationary, meaning the cameras may rotate freely or within a limited range but are not translated with respect to the ground. The method is particularly suited for simulating a golf course and the inventive processes are described herein as applied to golf course simulation. Describing the processes in this manner serves to illustrate the potential complexity of the invention's application. It will be understood, however, that the processes may be applied to any simulation of a suitable real-world event, including sporting events that may feasibly be presented from a single stationary camera in the real world, such as tennis, basketball, hockey, and other “arena” sports, and also including events that are more complex to present than golf.

In contrast to arena sports, a golf course offers a large and complex sporting environment. A golf course has one or more holes, each hole comprising a tee box, terrain, and a cup, organized in spatial relation as is known in the game of golf. The terrain comprises a fairway and a green, and may further comprise grounds outside the fairway and green that have varying texture, such as one or more gradients of “rough,” dense vegetation, or dirt, the texture affecting the lie of a golf ball. Each hole may further comprise background elements, one or more hazards, and environmental elements. The background elements may include houses or other buildings, mountains, bleachers, distant scenery, and other objects. Hazards include sand traps, ponds, streams, cart paths, and other commonly-known golf hazards. Environmental elements may include trees, bushes, and other foliage, signs, walking bridges, distance markers, hole boundaries, and other elements common to golf courses.

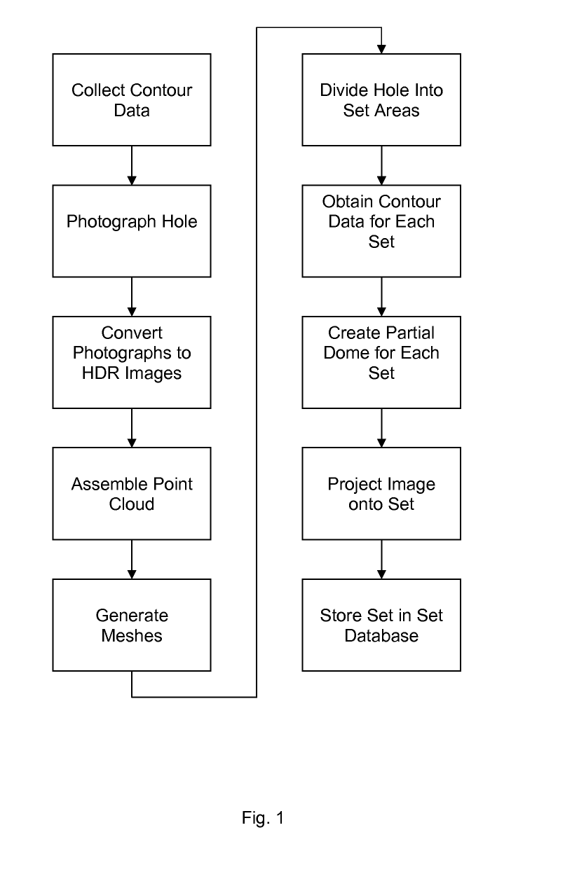

FIG. 1 illustrates a method of generating hole data for simulating the hole. Initially, each hole is electronically mapped. To electronically map a hole, three-dimensional contour data is collected for the entirety of the hole environment, including topography and spatial relationships of the tee box, green, terrain, hazards, and environmental elements. In the preferred embodiment, the contour data comprises a point cloud that represents the location and varying height of the terrain and environmental elements to a particular resolution. The “resolution” of the point cloud refers to the real-world distance between data points in the point cloud. The resolution may be uniform within the cloud, but preferably varies according to the desired level of detail at certain parts of the hole. In the preferred embodiment, the resolution is as fine as 1 cm on the green, up to 30 cm on the fairway and in the rough. A 3D scanner is used to generate the point cloud. Most preferably, a LIDAR scanner is used to generate the point cloud. The LIDAR scanner may be aerial, but is preferably ground-based. The LIDAR scanner uses light, preferably laser light, scanning from an angle of about −60 degrees to about 30 degrees with respect to horizontal, for up to 360 degrees around the LIDAR scanner. During each scan, the reflection of light off of environmental surfaces back to the LIDAR scanner produces a section of the point cloud. After the scan, the LIDAR scanner is moved from its position to a new position to perform the next scan. The scan positions may be predetermined using an overhead map of the hole and surveying, measuring, and marking instruments. Alternatively, the scan positions may be chosen in the field. The LIDAR scanner's position may be verified and recorded using GPS or other means.

In some simulations, a point cloud of contour data may not be needed. For example, a football field and a basketball court have planar surfaces with known dimensions. If position of the imaging device, described below, with respect to such a playing surface is known, the contour data may be modeled using geometric and trigonometric calculations rather than actual environmental measurements. The surfaces outside of the playing surface may also be modeled with such calculations. Alternatively, the point cloud collection method may be used in conjunction with calculation-based modeling to augment the playing surface's contour data.

Where the contour data is collected in sections, a computer may be used to assemble the contour data from the scanned sections into a complete representation of the scanned environment, such as the hole 20. If the contour data comprises a point cloud, the point cloud may be processed to produce a mesh of the terrain, hazards, and other elements. Specifically, the point cloud is surveyed to classify the data as terrain, hazard, environmental element, etc. The survey and classification may be performed manually or using an automated computing process. Then, adjacent terrain-classified points are joined to form a terrain mesh 24 comprising polygons, preferably triangles. Geometric primitives 25, such as discrete polygons, spheres, cubes, or other simple shapes, may be made to represent other simulation elements, such as trees and other environmental elements. The contour data may further be used to establish a heightfield for the terrain. The heightfield may be used by the processing engine described below to perform collision detection at a faster rate than if the processing engine used the mesh itself to do so.

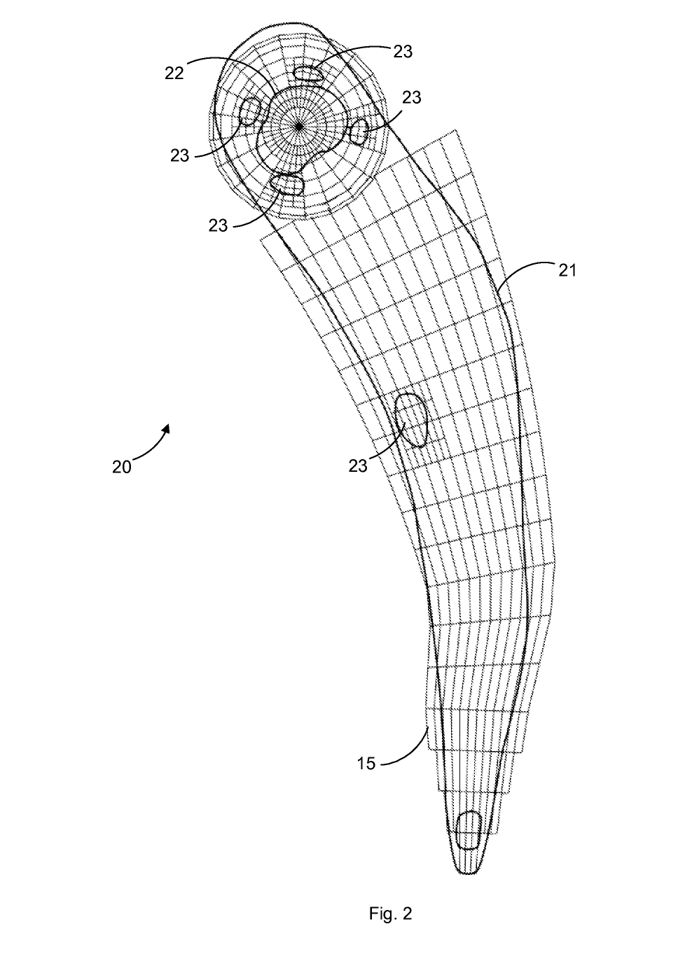

Referring to FIG. 2, electronic mapping of the hole continues by photographing the hole from multiple locations with a two-dimensional imaging device. The number of imaging device locations may vary depending on the length and width of the hole 20, amount of detail desired, and number and size of high-detail parts of the hole such as the green 22, sand traps 23, and other hazards. For example, in FIG. 2 the superimposed grid divides the real-world hole 20 into quadrilateral areas 15, and there is an imaging device location for each area 15: the geographical location is at the midpoint of the side of the quadrilateral that is furthest from the pin, and the imaging device heading is set either directly toward the pin or passing through a predetermined center of the green. Most preferably, photographs will be taken from between 100 and 500 locations for each hole 20, but fewer or more locations may be used. It will be understood that the total number of camera locations depends on the type of simulation being produced. In a golf simulation, a high number of locations is preferred to accommodate variations in terrain, the desired level of detail at particular locations within the hole 20, and the variability in ball location at the end of each swing, as described below. In contrast, a single camera location may be sufficient to present realistic simulations of football, basketball, or tennis contests.

The imaging device may be any device suitable for capturing photographic, preferably panoramic, representations of the hole. In the preferred embodiment, the imaging device is a HDR-capable panoramic camera. The camera is preferably placed on a tripod when collecting the image, so that the distance from the ground is known and the camera may be rotated smoothly to prevent blurring of the image. For HDR images, each photograph has a different exposure value from the other photographs taken at that location. The camera may be rotated up to 360 degrees, and may use special lenses and optics to capture an entire sphere around the camera at some locations. The photographs are saved electronically, preferably in raw image format. In the preferred embodiment, the photographs at each location are merged to create a single image with a high dynamic range of luminance between the lightest and darkest areas of the photographed scene. Most preferably, five photographs are taken at each location, the photographs having exposure values of neutral, +4 EV, +2 EV, −2 EV, and −4 EV. In other embodiments, three, seven, nine or another number of photographs may be taken at each location, and the range of exposure values may be balanced or imbalanced around the neutral setting. Additional tone mapping may be applied to the image to further enhance the contrast achieved in the HDR process.

The location of the camera is recorded in order to associate each image with the contour data. The camera's geographic location and heading at the time of taking the photographs may be ascertained by any positioning means, such as survey equipment or GPS. In the preferred embodiment, a differential GPS device is mounted to the tripod below the camera. The differential GPS device measures the geographic position and heading of the camera, preferably at a rate of about 10 measurements per second. The differential GPS device may output the measurements, such as to a laptop or other computing device attached to the differential GPS device. Further processing may be performed on the GPS measurements in order to associate a geographic location and heading with a particular image. For example, the camera may record the time the image was collected, and the associated geographic location and heading measurement is extracted from the GPS measurements, which are recorded 10 times every second, based on the time the image was collected. Alternatively, if a small number of camera locations is used, the geographical locations may be replaced with relative locations with respect to a target of the simulation. For example, in a basketball simulation, the court is the target and three cameras are used: an “arena” camera that pans left and right to view the court as is known in television broadcasts and video games, and “baseline” cameras positioned on each baseline. The location of each camera relative to the court is recorded in order to associate the images with the contour data.

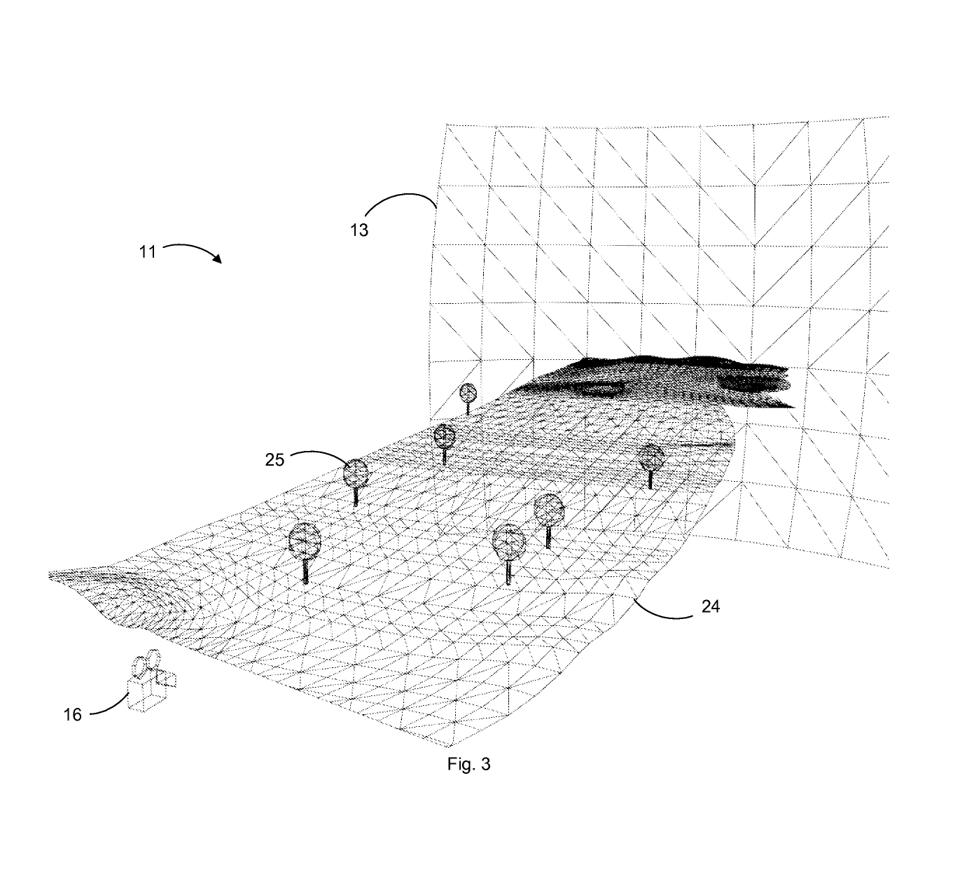

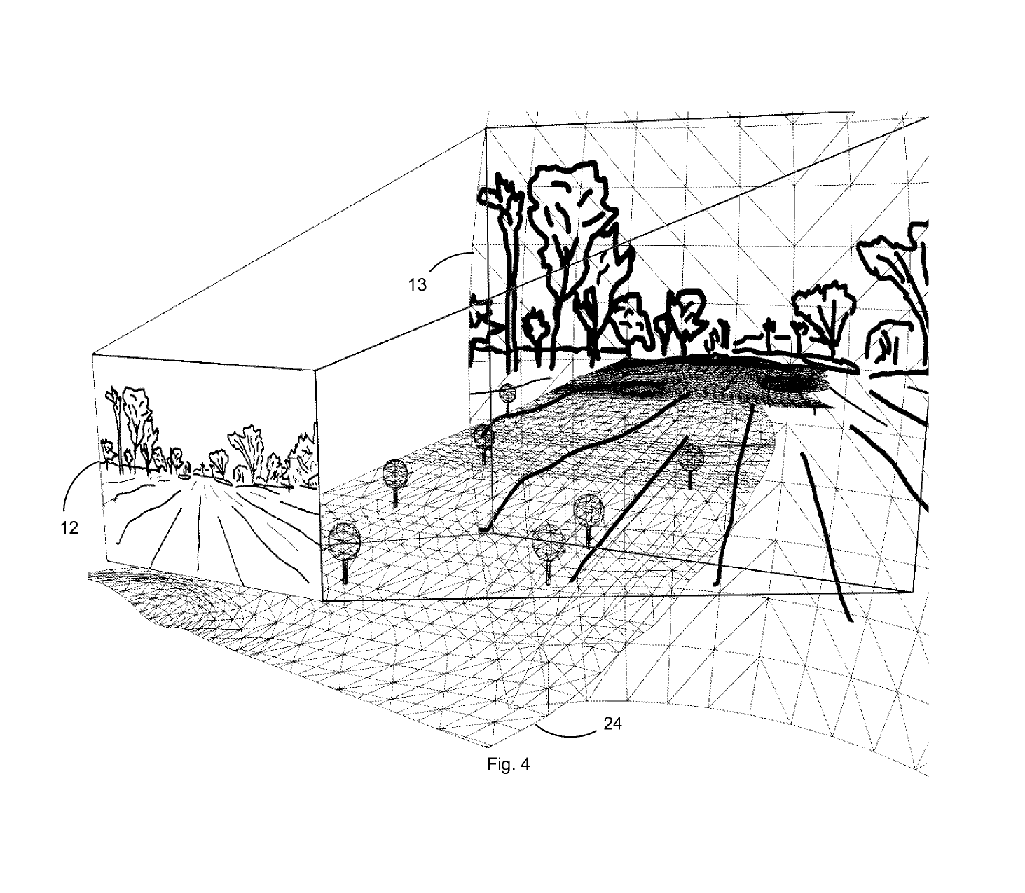

Referring to FIGS. 2-6, a set 11 is created for each collected image 12. In a first embodiment, the set 11 comprises a simulated camera 16 having a position and a heading, a backdrop 13, and one of the images 12 projected onto the backdrop 13. The virtual position and heading of the simulated camera are obtained from the geographical position and heading of the imaging device at the imaging device location where the image 12 was collected. Specifically, the imaging device's real-world or relative location and heading is transformed to a virtual position and heading in relation to the assembled contour data. The backdrop 13 comprises a mesh of polygons facing the simulated camera 16 and positioned a predetermined distance, with respect to the contour data, from the simulated camera 16. In one embodiment, the distance is determined by placing the center of the backdrop 13 at the intersection of the simulated camera's 16 heading and a predetermined hole 20 boundary (not shown). Typically, the hole 20 boundary is the perimeter of the hole 20, determined by the golf course owner or designer, beyond which a ball is considered “out of bounds.” In another embodiment, the hole 20 is divided into areas 15 and the backdrop 13 is placed at a boundary of each area 15 as described below. The backdrop 13 may extend both laterally and upward beyond the simulated camera's 16 field of view. The backdrop 13 may be planar or curved, and is preferably a partial or full sphere, having a radius equal to its distance from the camera.

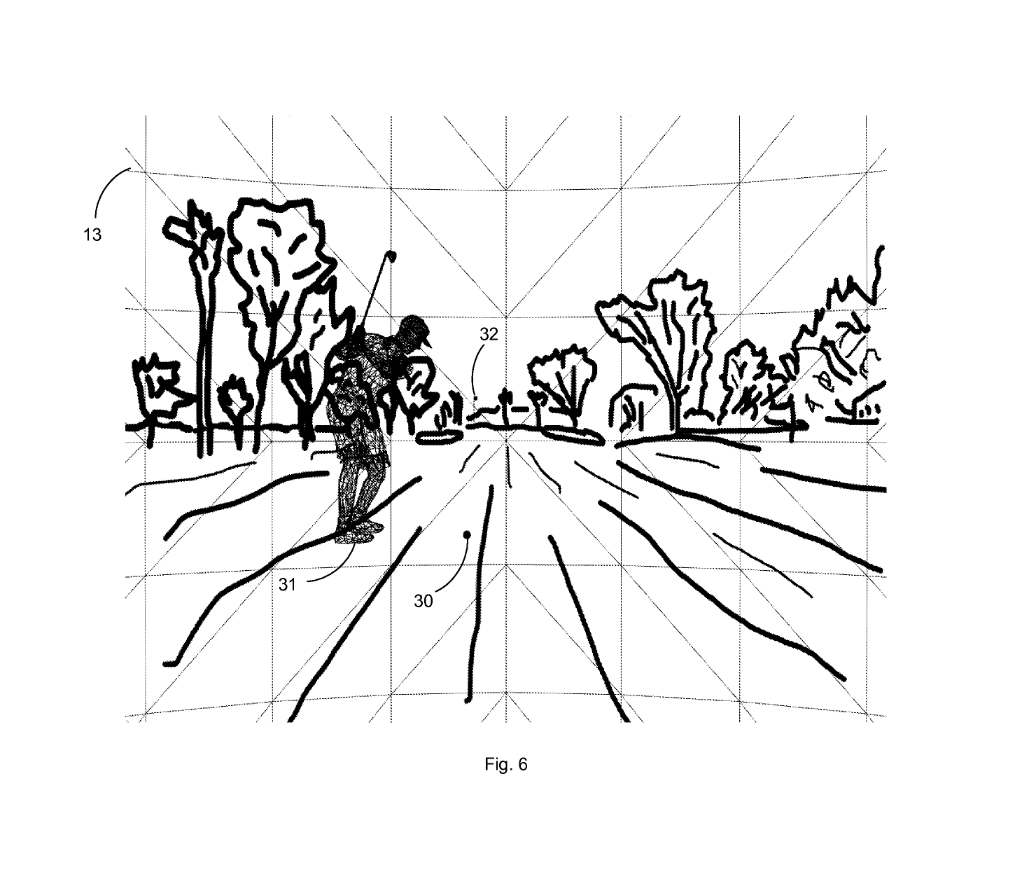

The image 12 is applied to the backdrop 13 by projecting the image 12 onto the polygonal faces of the backdrop 13 that are exposed to the simulated camera. This may include faces that are in the simulated camera's 16 non-rotated field of view, shown by example in FIG. 6, as well as faces that would be visible if the simulated camera 16 were rotated. The rotational extents may be limited to restrict the amount of backdrop 13 polygons that are viewable, or the simulated camera 16 may be able to rotate freely, in which case the backdrop 13 would be substantially spherical in shape. Preferably, the simulated camera 16 is permitted to rotate through the angular distance that is portrayed in the image 12. Correspondingly, the backdrop 13 preferably comprises the portion of a sphere required to receive a complete projection of the image 12. For example, if the image 12 was captured with a horizontal rotation extending from −90 degrees to 90 degrees, with respect to the original heading from the camera to the hole, the backdrop 13 would be a hemisphere with the simulated camera 16 at its center. The projection is performed using known texture mapping techniques. From the camera 16 view, the set 11 will closely resemble the image 12. The set 11 is then stored in a set database with the other sets 11 for the hole. As there may be hundreds of images 12 prepared through the mapping process, there may also be hundreds of sets 11 for each hole.

In the first embodiment, during the simulation, each set 11 selected to be rendered to the display is associated with a portion of the contour data during the rendering process. Specifically, a portion of the stored contour data represents the ground, environmental elements, and other simulation elements that are disposed between the simulated camera 16 and the backdrop 13. This portion is extracted from the contour data and inserted into the selected set 11 for rendering to the display as described below.

In a second embodiment, the set 11 further comprises the contour data, comprising meshes and geometric primitives 25, for a discrete area 15 of the hole 20. The area 15 to be represented is determined using the geographic position and heading of the camera when the image was captured. The hole 20 may be divided into areas 15 of equal size, but preferably the areas 15 are scaled according to the level of detail expected in the area 15. For example, areas 15 may be larger near the tee box and in the fairway, where significant amounts of terrain are traversed with a single shot, and smaller and more numerous in sand bunkers 23 and on the green 22, where there is greater variation of ball location and a higher level of detail is needed. Further, preferably the hole 20 is divided in a substantially gridlike manner except for the green 22, which is divided substantially radially as shown in FIG. 2. The radial division allows the simulated camera to always point towards the hole where the putt is to be directed. The backdrop 13 is positioned at the end of the area 15 opposite the simulated camera 16. The terrain mesh 24 and geometric primitives 25 are invisible in the set 11, and are used by the processing engine to simulate three-dimensional objects in the set 11 as described below.

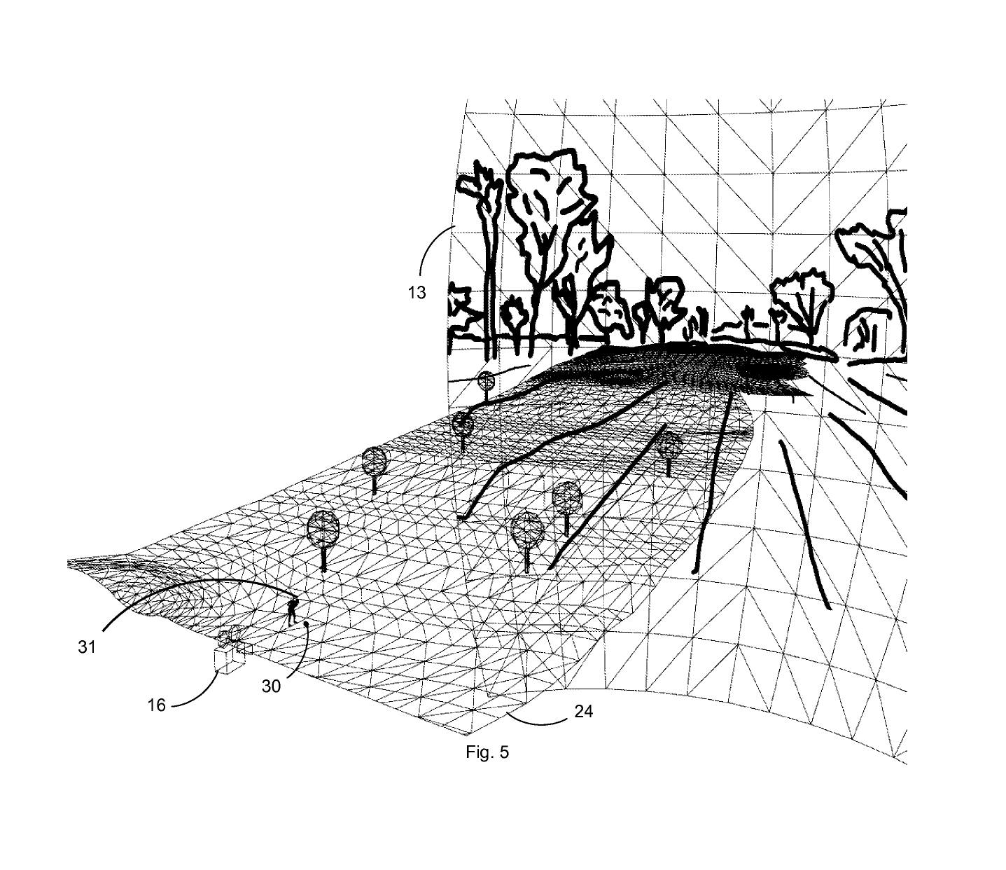

The simulated environment is created by rendering, in sequence, one or more particular sets to the display to present the sporting event. Referring to FIGS. 5-7, a processing engine creates the simulation of the hole 20 from the sets 11. In some embodiments, such as in the first embodiment for set 11 generation described above, the processing engine may first load all or a portion of the contour data, including the terrain mesh 24 and geometric primitives 25, of the hole 20 into memory. Preferably, however, the contour data for each set 11 is contained in the set 11 as described in the second embodiment above, which allows the processing engine to only load the required contour data into memory and to do so by referencing a single database instead of performing multiple database calls or calculations to align the set 11 and its contour data. The processing engine determines 71 the location of a golf ball 30 with respect to the contour data and selects 72 the proper set 11 for that location from the database. The processing engine places 73 the ball 30 within the set in order to determine the proper location of dynamic simulation elements such as the ball 30 and the player avatar 31. The processing engine generates 74 simulation elements needed for the simulation, inserts 75 the simulation elements into the selected set 11, and manages interactions between the simulation elements and the contour data, such as by evaluating physical rules and their effects on the elements, detecting collisions, and determining how to draw objects on the display. Simulation elements may include a virtual representation of the golf ball 30, the player 31, the pin 32, and other elements commonly found on a golf course such as spectators, golf carts, club bags, caddies, and divots. Special environmental elements and classes of terrain may also be rendered by the processing engine. For example, dust, smoke, grass, animated water, and other elements having movement may be added according to the terrain classification, manual inspection of the images, or other means of ascertaining proper locations of the elements. In an arena simulation, the images 12 of the arena or stadium are collected when the arena is empty, and the special environmental elements may include a crowd of spectators inserted into the set 11.

More particularly, for processing and display-rendering purposes, the simulation elements move in the three-dimensional space delineated by the contour data, including the terrain and the space above it. The movement is correlated to the sets 11 that are rendered to the display, which at the time of rendering are also three-dimensional spaces. When the ball 30 is at rest, the proper set 11 is the set 11 having a simulated camera 16 location that is closest to the ball 30, and that contains the ball 30 in the default field of vision, which corresponds to the stored heading for the simulated camera 16. The processing engine selects 72 the proper set 11, and renders the terrain mesh 24 and geometric primitives 25 to a depth buffer, which is used to occlude the objects in the set 11 when they travel behind hills or trees or land in a sand bunker 23. The terrain mesh 24 is invisible, meaning no texture or image is mapped to it. The terrain mesh 24 is simply used to detect collisions of the ball 30 with the ground and to determine whether and how to occlude simulation elements while rendering the simulated camera's 16 view.

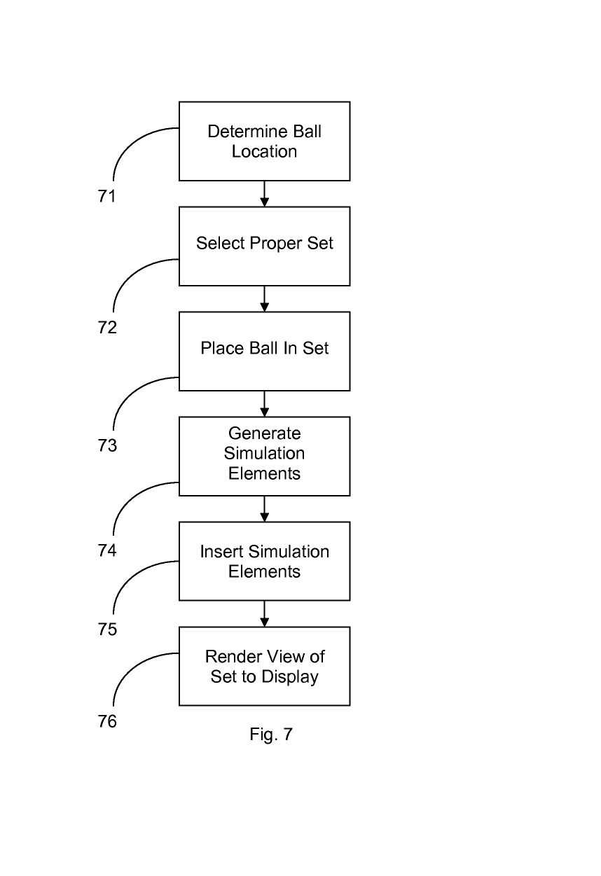

The view from the simulated camera 16 is rendered 76 to the display, including or followed by the ball 30, player 31, pin, 32 and other simulation elements. When the ball 30 is hit, the processing engine calculates the ball's 30 eventual resting place and may select one or more simulated camera 16 locations along the ball's 30 path that are appropriate for viewing the ball 30 in flight. For each selected simulated camera 16 location, the corresponding set 11 is loaded and the simulated camera 16 may track the ball. Because the images 12 projected onto the sets 11 are panoramic, the view from the simulated camera 16 portrays a realistic view of the hole 20 at substantially any camera angle that was originally recorded in the photograph, including angles directed back toward the tee box instead of the typical view toward the cup. The selected sets 11 are rendered sequentially in accordance with the flight of the ball 30 until the proper set 11 showing the ball 30 at rest, together with the player avatar 31 and other simulation elements, is displayed. The process of FIG. 7 is repeated as play continues, so that the sequential display of sets 11 showing the ball 30 at rest or in flight simulates the event.

While there has been illustrated and described what is at present considered to be the preferred embodiment of the present invention, it will be understood by those skilled in the art that various changes and modifications may be made and equivalents may be substituted for elements thereof without departing from the true scope of the invention. Therefore, it is intended that this invention not be limited to the particular embodiment disclosed, but that the invention will include all embodiments falling within the scope of the appended claims.

We claim:

1. A method for producing a video simulation of a real-world environment, the method comprising using a computer to:
a. store one or more sets in a set database, the sets together virtually representing of the environment, each set comprising:
i. an HDR image of the environment collected with an HDR imaging device having a known location and heading;
ii. a simulated camera having a virtual position and heading that corresponds to the known location and heading of the HDR imaging device, and further having a three-dimensional view of the set; and
iii. a backdrop positioned a predetermined distance from the simulated camera and comprising one or more polygons onto which the HDR image is projected, the polygons facing the simulated camera;
b. determine a proper set to be displayed to a user;
c. render the proper set to a display; and
d. repeat steps d and e as needed to produce the simulation.

2. The method of claim 1 wherein the backdrop comprises a plurality of polygons formed into a curved polygonal mesh.

3. The method of claim 2 wherein the mesh has a radius equal to the backdrop's distance from the simulated camera.

4. The method of claim 1 wherein rendering the proper set to the display comprises rendering the simulated camera's three-dimensional view into a planar projection.

5. The method of claim 4 further comprising using the computer to:
a. generate one or more simulation elements based on the determination of the proper set;
b. insert the simulation elements into the simulated camera's three-dimensional view within the proper set; and
c. repeat steps a and b when steps b and c of claim 1 are repeated.

6. The method of claim 5 wherein each set further comprises contour data representing a discrete area of the environment, the contour data being disposed in the simulated camera's three-dimensional view, between the simulated camera and the backdrop.

7. The method of claim 6 wherein rendering the proper set to the display further comprises:
a. using the contour data to place the simulation elements in a depth buffer; and
b. positioning and occluding simulation elements and the backdrop according to the depth buffer.

8. The method of claim 6 wherein the contour data comprises a terrain mesh.

9. The method of claim 8 wherein the contour data further comprises a heightfield.

10. The method of claim 8 wherein the contour data further comprises at least one geometric primitive, and wherein one of the simulation elements is rendered onto each of the geometric primitives.

11. The method of claim 4 wherein, within one or more of the sets:
a. the HDR image is a panoramic image extending horizontally from a first angle to a second angle; and
b. the simulated camera is configured to rotate between the first angle and the second angle.

12. The method of claim 11 wherein, within each set in which the HDR image is a panoramic image:
a. the panoramic image further extends vertically from a third angle to a fourth angle; and
b. the simulated camera is further configured to rotate between the third angle and the fourth angle.

13. The method of claim 12 wherein the panoramic image is a composite of a plurality of HDR images all collected at the same location.

14. A method for producing a video simulation of a real-world environment, the method comprising:
a. collecting contour data representing the environment;
b. collecting one or more HDR images of the environment at one or more imaging locations, each imaging location having a known geographic location and heading;
c. creating and storing, in a set database on a computer, one or more sets, each set comprising:
i. one or more of the HDR images that were collected at the same geographic location;
ii. a simulated camera having a virtual position and heading that corresponds to the known geographic location and heading at which the HDR images were collected, and further having a three-dimensional view of the set; and
iii. a backdrop positioned a predetermined distance from the simulated camera and comprising one or more polygons onto which the HDR images are projected, the polygons facing the simulated camera;
d. determining the proper set to be displayed to a user;
e. rendering the set to a display; and
f. repeating steps d and e as needed to create the simulation.

15. The method of claim 14 further comprising a plurality of the sets, wherein each of the sets represents a discrete area of the environment.

16. The method of claim 15 wherein determining the proper set to be displayed to the user comprises:
a. calculating a position of a simulated ball with respect to the contour data; and
b. selecting, as the proper set, the set in which:
i. the virtual position of the simulated camera is the closest to the simulated ball; and
ii. the simulated camera contains the simulated ball within the simulated camera's three-dimensional view along the simulated camera's virtual heading.

17. The method of claim 16 wherein:
a. the contour data comprises a point cloud; and
b. each of the sets further comprises a terrain mesh created from a discrete portion of the contour data, the terrain mesh being disposed in the simulated camera's three-dimensional view between the simulated camera and the backdrop; and
c. one or more of the sets further comprises at least one geometric primitive positioned on the terrain mesh.

18. The method of claim 17 wherein rendering the proper set to the display comprises:
a. if the proper set comprises at least one geometric primitive, associating a simulation element with each geometric primitive;
b. using the contour data to place the terrain mesh and simulation elements in a depth buffer;
c. positioning and occluding the terrain mesh, the simulation elements, and the backdrop according to the depth buffer;
d. rendering the simulated camera's three-dimensional view into a planar projection; and
e. presenting the planar projection on the display.

19. A method for producing a video simulation of a real-world environment, the method comprising:
a. using a device to collect contour data representing the environment, the contour data comprising a point cloud;
b. using one or more HDR imaging devices to collect at least one HDR image of the environment at between 100 and 500 imaging device locations, each imaging device location having a known geographic location and heading;
c. transferring the contour data and HDR images onto a computer;
d. using the computer to create a plurality of sets, each set representing a discrete area of the environment viewed from the virtual position and heading that corresponds to the known geographic location and heading at the imaging device location where the image of the set was collected, each set comprising:
i. one of the HDR images of the environment;
ii. a simulated camera having a virtual position and heading that corresponds to the known geographic location and heading at the imaging device location where the HDR image of the set was collected;
iii. a backdrop positioned a predetermined distance from the simulated camera and comprising a curved polygonal mesh onto which the HDR image is projected, the polygonal mesh facing the simulated camera and having a radius equal to the backdrop's distance from the simulated camera;
iv. a terrain mesh constructed from a portion of the contour data and disposed between the simulated camera and the backdrop; and
v. one or more geometric primitives positioned on the terrain mesh;
e. determining a rest location of a simulated golf ball with respect to the contour data;
f. using the rest location of the simulated golf ball to determine the proper set to be displayed to a user;
g. rendering the proper set to a display by:
i. placing the simulated golf ball and a player avatar in the proper set;
ii. associating a simulation element with each geometric primitive;
iii. organizing the simulated golf ball, player avatar, simulation elements, and terrain mesh in a depth buffer according to the contour data;
iv. positioning and occluding the contents of the depth buffer;
v. rendering the contents of the depth buffer and the backdrop within the simulated camera's view into a planar projection; and
vi. presenting the planar projection on the display; and
h. repeating steps e-g as needed to create the simulation.

20. The method of claim 19 wherein:
a. within at least one of the sets:
i. the HDR image is a panoramic image extending horizontally from a first angle to a second angle and extending vertically from a third angle to a fourth angle; and
ii. the simulated camera is configured to rotated between the first, second, third, and fourth angles; and
b. if the HDR image in the proper set is a panoramic image, rendering the proper set to the display further comprises determining the angle at which the simulated camera is rotated from the simulated camera's virtual heading.
